(19) United States
(12) Patent Application Publication
(10) Pub. No.: US 2025/0147904 A1
(43) Pub. Date: May 8, 2025

(54) PAGE DETECTION USING RECENCY SCORE FILTERS

(71) Applicant: Rambus Inc., San Jose, CA (US)

(72) Inventors: Taeksang Song, San Jose, CA (US); Evan Lawrence Erickson, Chapel Hill, NC (US)

(21) Appl. No.: 18/928,868

(22) Filed: Oct. 28, 2024

Related U.S. Application Data
(60) Provisional application No. 63/596,786, filed on Nov. 7, 2023.

(51) Int. Cl. G06F 13/16; G06F 12/02

(52) U.S. Cl. CPC G06F 13/1673; G06F 13/1689; G06F 12/0246

(57) ABSTRACT

A memory buffer device and memory module for accurate hot and cold page detection is disclosed. The memory buffer device is coupled to a device memory including a plurality of regions. The memory buffer device identifies frequently accessed regions of the plurality of regions by counting accesses to the plurality of regions at a first granularity. The frequently accessed regions are associated with counters that satisfy a threshold criterion and are further tracked using a filter at a second granularity. The second granularity is smaller than the first granularity.

### RELATED APPLICATIONS

This application claims the benefit of U.S. Provisional Patent Application No. 63/596,786 filed Nov. 7, 2023, entitled “PAGE DETECTION USING RECENCY SCORE FILTERS”, the contents of which are incorporated by reference in its entirety herein.

### TECHNICAL FIELD

The disclosure pertains to memory access devices, more specifically to systems and techniques that track accesses to regions of memory.

### BACKGROUND

Modern computer systems generally include one or more memory devices, such as those on a memory module. The memory module may include, for example, one or more random access memory (RAM) devices or dynamic random access memory (DRAM) devices. A memory device can include memory banks made up of memory cells that a memory controller or memory client accesses through a command interface and a data interface within the memory device. The memory module can include one or more volatile memory devices. The memory module can be a persistent memory module with one or more non-volatile memory (NVM) devices.

### BRIEF DESCRIPTION OF THE DRAWINGS

The present disclosure is illustrated by way of example, and not by way of limitation, in the figures of the accompanying drawings.

FIG. 1 is a block diagram of an example computing system with a host and memory module that includes a memory buffer device, according to at least one embodiment.

FIG. 2 is a block diagram of an example computing system with a host and compute express link module that includes a memory buffer device, according to at least one embodiment.

FIG. 3A is a diagram illustrating storing access counters in an address indirection table, according to at least one embodiment.

FIG. 3B is a diagram illustrating storing access counters in a translation lookaside buffer, according to at least one embodiment.

FIG. 4 is a flow diagram of an example method of tracking memory accesses at a first granularity and at a second granularity, according to at least one embodiment.

### DETAILED DESCRIPTION

The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

In memory systems including memory components implemented using different types of media, the characteristics of the media can vary from one media type to another. One example of a characteristic associated with a memory component is data density. Data density corresponds to an amount of data (e.g., bits of data) that can be stored in each memory cell of a memory component. Another example of a characteristic of a memory component is access speed. The access speed corresponds to an amount of time required to access (e.g., read, write) data stored at the memory component.

In some memory systems, the storage media used as primary memory may have certain characteristics, such as having access times, thereby causing latencies when servicing data access requests from the host system. These memory systems may implement one or more memory tiers using different storage media types. Depending on the temperature of the data (e.g., how frequently the data has been or is likely to be accessed), the data can be stored at a corresponding memory tier. For example, so called “hot” data (e.g., data that has been or is likely to be frequently accessed) can be stored in a “near” memory tier that is implemented using media with faster access times in order to reduce latencies associated with host data accesses, but that is fairly expensive and thus may be present in limited quantities in the memory system. In addition, so called “cold” data (e.g., data that has not been or it not likely to be as frequently accessed) can be stored in a “far” memory tier that is implemented using media that has slower access times but is potentially more reliable and/or less expensive than the media used in the near memory tier. As an example, a hybrid memory system may use high-speed and expensive dynamic random access memory (DRAM) as a cache memory for low-cost but slower non-volatile memory to have an increased memory capacity at a reduced cost per bit while still maintaining a desired level of performance (e.g., reduced latencies).

Memory systems that utilize this hybrid approach are faced with the challenge of identifying which data to move to the limited near memory tier and which data can be kept in the more ample far memory tier. One goal is to identify the hot data that has either been used recently and/or is likely to be requested by the host system again in the near future so that such hot data can be kept in the near memory tier for fast host access. The remaining cold data that has not frequently been accessed and/or is not likely to be requested by the host system in the immediate future can be kept in the far memory tier and accessed as needed.

One option is to track access statistics for the data, such as at the page level. For example, access counters can be maintained for memory pages, where a respective counter is incremented each time a corresponding page is accessed, and the memory pages having the highest associated access counts can be maintained in the near memory tier. However, the size of current memory systems, including the volume of data stored therein, makes access tracking at the page level granularity highly impractical, as the resources and overhead needed to do so for potentially billions of pages would overwhelm the memory system. The memory system would suffer increased latency due to the access tracking overhead, would have reduced capacity to store host data, and would offer an overall lower quality of service to the host system.

Aspects of the present disclosure overcome these challenges and others by using multiple filters to track accesses to regions of memory at different granularities. In some embodiments, a memory buffer device includes the multiple filters. In some embodiments, a memory module includes the multiple filters. For example, a first filter (e.g., pre-filter) may track memory accesses at a first granularity (e.g., 4 megabytes (MB)). Whenever a host device requests an address within a region tracked by the first filter at the first granularity (e.g., within a particular 4 MB region), the first filter may increment a counter associated with that region. The first filter may store counters associated with tracked regions in one or more address translation tables. For example, in some embodiments, the first filter may store the values of each counter within an address indirection table (AIT). In some embodiments, the counter values may be stored within a translation lookaside buffer (TLB). The value of the counter may represent a recency score indicating whether or not and/or how much a region has been accessed recently in time.

In some embodiments, each region tracked by the first filter at the first granularity may have an associated m-bit counter. For example, each region may have a 3-bit counter that identifies how many times the region has been accessed before the counter is reset. In some embodiments, the counter may be configured so it cannot overflow. In some embodiments, each region may have a 1-bit counter that identifies whether or not the region has been accessed and does not indicate how many times it has been accessed.

In some embodiments, each region tracked by the first filter at the first granularity may have more than one (e.g., n) m-bit counters. For example, if each region has 4 1-bit counters, the first 1-bit counter may track whether or not the region has been accessed during a predetermined duration of time (e.g., 10 nanoseconds). After the predetermined duration of time has expired, the second 1-bit counter may begin tracking memory accesses to the region, and so forth. As tracking changes from the first 1-bit counter to the second 1-bit counter, the second 1-bit counter may be reset to ensure accurate tracking. In some embodiments, all n counters may be reset at the same time. Thus, each m-bit counter may track memory accesses during a predetermined duration of time. After n time periods, the first 1-bit counter may be used to track memory accesses to the region again, thus looping around through the n m-bit counters. In some embodiments, all counters for a particular region are reset when a page table entry corresponding to the region is evicted from an address indirection table (AIT) or TLB.

Using the counters associated with each tracked region, a region can be identified as “hot” or “cold.” In some embodiments, a cold threshold criterion may be used to identify cold regions of memory. For example, in some embodiments, any regions with counters that are all zero may be considered cold. In another embodiment, any regions with at least x of n counters that are zero may be considered cold. In some embodiments, a different cold threshold criterion may be used. In some embodiments, a hot threshold criterion may be used to identify hot regions of memory. For example, any regions with at least one non-zero counter may be considered hot. In some embodiments, any regions with at least x of n counters that are non-zero may be considered hot. In some embodiments, only regions with at least one counter that exceeds a predetermined threshold (e.g., 2, 3, 4) may be considered hot.

A second filter may be used to track hot regions at a second granularity. In some embodiments, the second filter is a bloom filter. In some embodiments, the second filter is a counting bloom filter. In some embodiments, more than one pre-filter may be used to track memory accesses before a bloom filter tracks memory accesses. A first pre-filter may track memory accesses at a first granularity (e.g., 4 MB), a second pre-filter may track memory accesses at a second granularity (e.g., 2 MB), and a bloom filter may track memory accesses at a third granularity (e.g., 4 kilobytes (KB)).

Memory accesses to hot regions (as identified by the one or more pre-filters, as described above) may be tracked by a bloom filter at a granularity different than (e.g., smaller than, larger than) the granularities of the one or more pre-filters. If a memory access is for a cold region, the access may not be tracked by the bloom filter. In some embodiments, if a memory region tracked at a large granularity is identified as hot (or cold), the memory regions within that region tracked at a smaller granularity may also be identified as hot (or cold), even if some of the memory regions tracked at the smaller granularity are cold (or hot). In some embodiments, memory accesses may be tracked by the one or more pre-filters at the same time as memory accesses are being tracked by the bloom filter.

The advantages of the disclosed memory device include but are not limited to reduced power consumption of the memory device as only a limited number of memory accesses (e.g., only memory accesses for hot regions) cause a bloom filter to be updated and reduced hardware complexity for a given false identification rate as compared to a memory device using a bloom filter without a pre-filter. Additionally, the false identification rate of a bloom filter can be reduced using the disclosed pre-filter because the number of updates to the bloom filter will be reduced and infrequently accessed regions of memory will not be tracked by the bloom filter.

### System Architecture

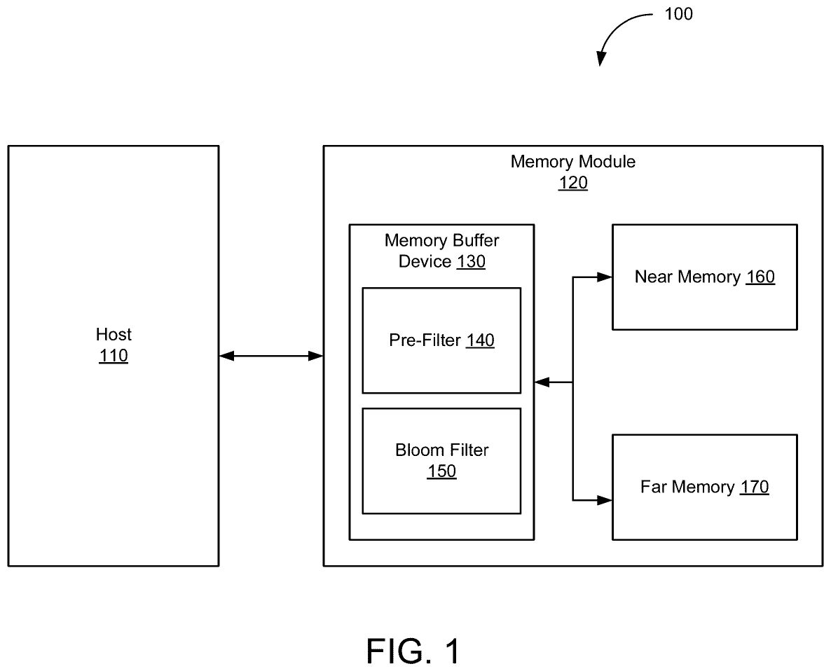

FIG. 1 is a block diagram of an example computing system 100 with a host 110 and memory module 120 that includes a memory buffer device 130, according to at least one embodiment. In some embodiments, memory module 120 includes various memory components, such as memory buffer device 130, near memory 160, and far memory 170. Near memory 160 and far memory 170 may be implemented using various media types and can include, for example, volatile memory components, non-volatile memory components, and/or a combination thereof. In some embodiments, near memory 160 and far memory 170 are each one of a dual in-line memory module (DIMM), a small outline DIMM (SO-DIMM), and/or a non-volatile dual in-line memory module (NVDIMM). In some embodiments, near memory 160 and far memory 170 are included together in a single package. In some embodiments, near memory 160 and far memory 170 may be physically separated. For example, while near memory 160 may be located physically near memory buffer device 130, far memory 170 may be located elsewhere.

Host 110 may use memory module 120 to, for example, write data to the memory components and/or read data from the memory components. As used herein, “coupled to” generally refers to a connection between components, which can be an indirect communicative connection or direct communicative connection (e.g., without intervening components), whether wired or wireless, including connections such as electrical, optical, magnetic, etc. Host 110 may be a computing device such as a desktop computer, laptop computer, network server, mobile device, embedded computer (e.g., one included in a vehicle, industrial equipment, or a networked commercial device), or such computing device that includes a memory and a processing device. Host 110 may include or be coupled to memory module 120 such that host 110 can read data from and/or write data to memory module 120. In some embodiments, host 110 is coupled to memory module 120 via a physical host interface. Examples of a physical host interface include, but are not limited to, a serial advanced technology attachment (SATA) interface, a peripheral component interconnect express (PCIe) interface, a compute express link (CXL) interface, universal serial bus (USB) interface, Fibre Channel, Serial Attached SCSI (SAS), etc. The physical host interface may be used to transmit data between host 110 and memory module 120. Host 110 may further utilize an NVM Express (NVMe) interface to access the memory components when memory module 120 is coupled with host 110 by a PCIe interface. The physical host interface may provide an interface for passing control, address, data, and/or other signals between memory module 120 and host 110.

Memory components of memory module 120 may include any combination of different types of non-volatile memory components and/or volatile memory components. For example, near memory 160 may be used as a near memory based on dynamic random access memory (DRAM), or some other type of volatile memory. In some embodiments, far memory 170 may be used as a far memory based on NAND-type flash memory, a cross-point array of non-volatile memory cells, and/or some other type of non-volatile memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

Memory module 120 may include memory buffer device 130, which may include pre-filter 140 and bloom filter 150. Pre-filter 140 may be a recency score filter that allows memory accesses to update bloom filter 150 only if the recency score of a particular region satisfies a threshold criterion, as described herein. In some embodiments, bloom filter 150 is a counting bloom filter.

Pre-filter 140 may track memory accesses to regions of memory (e.g., regions of near memory 160 and/or regions of far memory 170) at a first granularity. In some embodiments, the first granularity may be 4 MB, such that regions of memory are tracked at a granularity of 4 MB. For example, whenever an address is requested within a given 4 MB region of memory, a counter associated with that region may be incremented to track the memory access. In some embodiments, each region may have a single m-bit counter (e.g., 3 bits). In some embodiments, each region may have more than one (e.g., n) 1-bit counters. In some embodiments, each region may have more than one (e.g., n) m-bit counters. In some embodiments, when there is more than one counter for a region, each counter may be updated during a predetermined duration of time (e.g., 10 nanoseconds) before using the next counter to track memory accesses. When changing from tracking memory accesses with a first counter of a region to a second counter of the region, the second counter may be reset. When the duration of time has expired to track memory access with the last counter of a region, tracking memory accesses to the region may continue by looping around to reset and use the first counter.

The counters associated with a region may be used to generate a recency score for the region. For example, the value of each counter for a region may be aggregated (e.g., summed) to obtain a recency score for the region. If the recency score for the region satisfies a threshold criterion (e.g., exceeds a predetermined value), the region may be considered “hot” and subsequent memory accesses for the region may be tracked at a second granularity by bloom filter 150. In some embodiments, the first granularity may be larger than the second granularity. For example, bloom filter 150 may track memory accesses at a 4 KB granularity. Thus, bloom filter 150 may track memory accesses to a subset of the regions tracked by pre-filter 140 identified as frequently accessed by pre-filter 140 based on the recency score of each region.

Memory access for regions that do not satisfy the threshold criterion (“cold” regions) may not be tracked by bloom filter 150. In some embodiments, a first threshold criterion may be used to determine which regions are “hot,” and a second threshold criterion may be used to determine which regions are “cold.” By limiting the number of memory accesses that are tracked by bloom filter 150, power consumption for memory module 120 can be reduced, and the number of false positives returned by bloom filter 150 can also be reduced.

In some embodiments, bloom filter 150 may further identify hot and cold regions of memory in order to prioritize accessing memory of those regions. For example, regions of memory in far memory 170 that are considered hot by bloom filter 150 may be moved to near memory 160 or to a memory directly coupled to host 110. On the other hand, regions of memory in near memory 160 that are considered cold by bloom filter 150 may be moved to far memory 170. In some embodiments, at least a portion of at least one frequently accessed region (e.g., a region considered hot by pre-filter 140, a region considered hot by bloom filter 150) may be cached by memory buffer device 130.

In some embodiments, pre-filter 140 may track memory accesses for a first duration of time, and bloom filter 150 may track memory accesses for a second duration of time. In some embodiments, pre-filter 140 may be reset at the end of the first duration of time and bloom filter 150 may be reset at the end of the second duration of time. The end of the first duration of time and the end of the second duration of time may occur at different times. Thus, pre-filter 140 and bloom filter 150 may be reset at different times. In some embodiments, the first duration of time is the same as the second duration of time, such that pre-filter 140 and bloom filter 150 may be tracking memory accesses simultaneously and may be reset at the same time.

In some embodiments, pre-filter 140 may track memory accesses at the first granularity only if a memory request associated with the memory access satisfies a counting criterion. For example, in some embodiments, pre-filter 140 may only track memory accesses at the first granularity if the memory request is for an address within a range of counting addresses (e.g., a range of addresses with an indicator that they should be tracked by the pre-filter). In some embodiments, pre-filter 140 may only track memory accesses at the first granularity if the memory request is from a first host of a plurality of hosts. For example, memory accesses from a first device may be tracked by pre-filter 140 while memory accesses from a second device may not be tracked by pre-filter 140. In some embodiments, pre-filter 140 may only track memory accesses at the first granularity if the memory request is for an address associated with a first virtual machine of a plurality of virtual machines. For example, the memory request may include a context key identifier (CKID) that indicates which virtual machine of a plurality of virtual machines the request is associated with. Pre-filter 140 may be configured to only track memory accesses associated with select virtual machines based on the CKID included in the memory request.

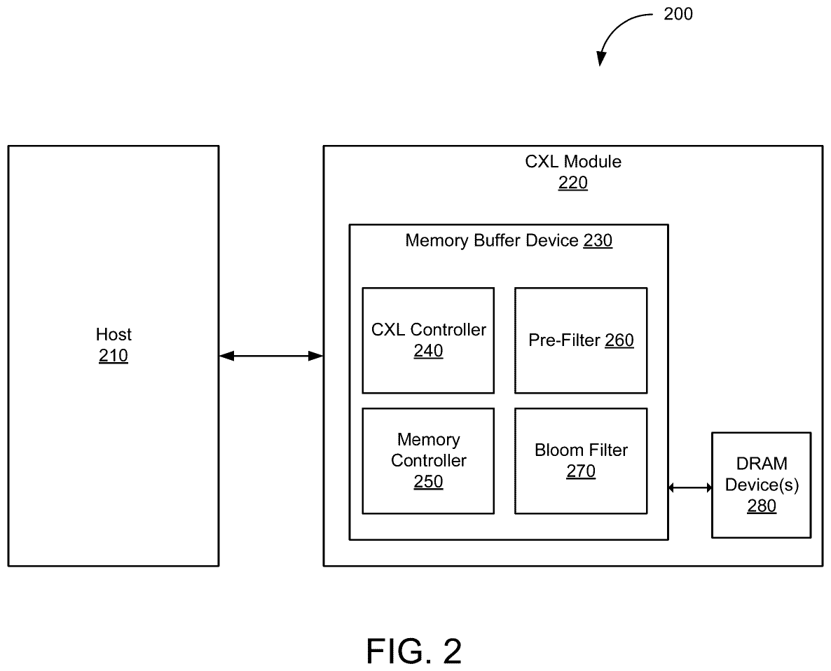

FIG. 2 is a block diagram of an example computing system 200 with a host 210 and Compute Express Link (CXL) module 220 that includes a memory buffer device 230, according to at least one embodiment. Host 210 may be a computing device that accesses remote memory (e.g., a computing device in a datacenter). Host 210 may be coupled to CXL module 220, which may include memory buffer device 230 and one or more DRAM device(s) 280. Memory buffer device 230 may include CXL controller 240 and memory controller 250. In at least one embodiment, memory buffer device 230 may be implemented in a memory expansion device, such as a CXL memory expander SoC of a CXL NVM module or a CXL module. CXL controller 240 may receive (e.g., from host 210) one or more memory access commands of a remote memory protocol, such as CXL protocol, Gen-Z, Open Memory Interface (OMI), Open Coherent Accelerator Processor Interface (OpenCAPI), and/or the like. CXL controller 240 may also receive (e.g., from host 210) one or more management commands of the remote memory protocol. In some embodiments, memory controller 250 may be coupled to DRAM device(s) 280 and may be used to access (e.g., read, write) data on DRAM device(s) 280.

Memory buffer device 230 may include pre-filter 260 and bloom filter 270. Pre-filter 260 may track memory accesses to DRAM device(s) 280 at a first granularity and may generate a recency score for each tracked region. When the recency score of a region satisfies a threshold criterion (e.g., exceeds a “hot” threshold value), subsequent memory accesses to that region may be further tracked by bloom filter 270 at a second granularity. The counters associated with a region that are used to calculate a recency score may be reset periodically (e.g., after a predetermined amount of time, when a page table entry associated with the region is evicted from a page table, etc.). After the counters are reset, a region that was considered “hot” by pre-filter 260 may be considered “cold” (thus, memory accesses may not be tracked by bloom filter 270) until the recency score for the region again satisfies the threshold criterion.

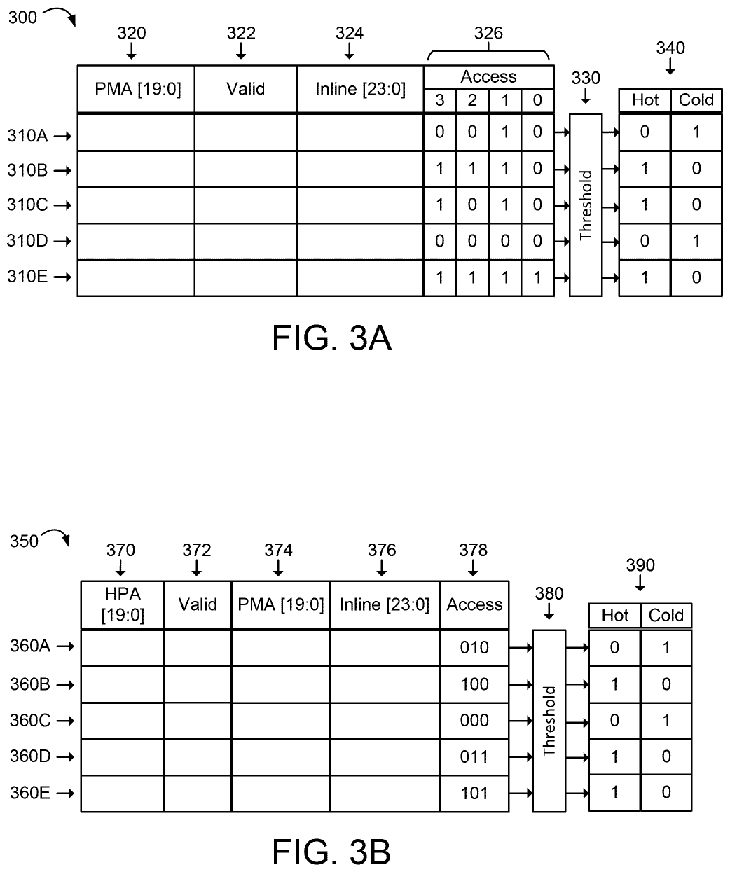

FIG. 3A is a diagram illustrating storing access counters in an address indirection table (AIT) 300, according to at least one embodiment. AIT 300 may include one or more regions 310A-E containing information related to one or more corresponding memory regions. For example, each entry 310A-E in AIT 300 may include a physical memory address (PMA) value 320, a valid indicator 322 (e.g., identifying if the table entry is still valid), and an inline value 324 (e.g., address for redirection to additional metadata). For simplicity, PMA values 320, valid indicators 322, and inline values 324 are not included for each entry 310A-E of AIT 300. AIT 300 may also include access counters 326 for each entry 310A-E. For example, AIT 300 depicts 4 1-bit counters for each entry 310A-E. Access counters 326 may show whether the memory region corresponding to an entry was accessed during a corresponding time period and/or how many times the memory region was accessed during that corresponding time period. For example, if a particular counter is used for a duration of 10 nanoseconds, access counter 326-3 may indicate whether the corresponding memory region was accessed 30-40 nanoseconds ago. Access counter 326-2 may indicate whether the corresponding memory region was accessed 20-30 nanoseconds ago. Access counter 326-1 may indicate whether the corresponding memory region was accessed 10-20 nanoseconds ago. Access counter 326-0 may indicate whether the corresponding memory region was accessed 0-10 nanoseconds ago. The value of each counter may be aggregated (e.g., summed) and evaluated by a threshold criterion (e.g., threshold 330). If the aggregated counter value satisfies the threshold criterion (e.g., aggregated counter value is greater than or equal to 2), the memory region corresponding to the entry may be considered “hot” (as indicated by table 340). If the aggregated counter value does not satisfy the threshold criterion, the memory region corresponding to the entry may be considered “cold” (as indicated by table 340). In some embodiments, table 340 is not stored in memory.

FIG. 3B is a diagram illustrating storing access counters in a translation lookaside buffer (TLB) 350, according to at least one embodiment. TLB 350 may include one or more entires 360A-E containing information related to one or more corresponding memory regions. For example, each entry 360A-E in TLB 350 may include a host physical address (HPA) value 370, a valid indicator 372, a PMA value 374, and an inline value 376. For simplicity, HPA values 370, valid indicators 372, PMA values 374, and inline values 376 are not included for each entry 360A-E of TLB 350. TLB 350 may also include access counters 378 for each memory region. For example, TLB 350 depicts 1 3-bit counter for each entry 360A-E. Access counters 378 may show whether the memory region corresponding to an entry was accessed during a particular time period and/or how many times the memory region was accessed during that time period. For example, if a memory region was accessed twice during the duration of the tracking (e.g., before the counter was reset), access counter 378 may have a binary value of “010.” The value of each counter may be evaluated by a threshold criterion (e.g., threshold 380). If the counter value satisfies the threshold criterion (e.g., the value is greater than or equal to 3), the memory region corresponding to the entry may be considered “hot” (as indicated by table 390). If the counter value does not satisfy the threshold criterion, the memory region corresponding to the entry may be considered “cold” (as indicated by table 390). Table 390 may not be stored in memory, such that whether a region is considered “hot” or “cold” by a filter (e.g., pre-filter 140 of FIG. 1, pre-filter 260 of FIG. 2) may be calculated on the fly when a region is accessed.

In some embodiments, the value of each counter (e.g., access counters 326 and/or access counters 378) may be evaluated by a “hot” threshold criterion and by a “cold” threshold criterion. In some instances, the memory region associated with a counter value may not be considered “hot” or “cold.” For example, if a memory region has a counter value of 3, the region may not be considered “hot” if the “hot” threshold criterion requires a counter value greater than or equal to 4, and the region may not be considered “cold” if the “cold” threshold criterion requires a counter value less than or equal to 1. In some embodiments, memory regions that are not considered “hot” or “cold” may remain in their current location in memory (e.g., may not be moved to near memory, may not be moved to far memory).

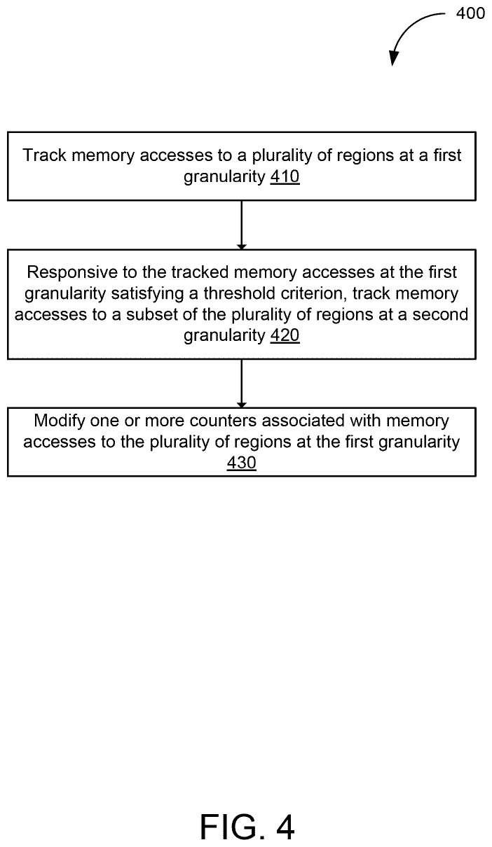

FIG. 4 is a flow diagram of an example method 400 of tracking memory accesses at a first granularity and at a second granularity, according to at least one embodiment. The method 400 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 400 is performed by the memory buffer device 130 of FIG. 1 and/or the memory buffer device 230 of FIG. 2. Alternatively, other devices can perform the method 400.

Referring to FIG. 4, the method 400 begins with the processing logic tracking memory accesses to a plurality of regions of memory at a first granularity (block 410). At block 420, the processing logic may, responsive to the tracked memory accesses at the first granularity satisfying a threshold criterion, track memory accesses to a subset of the plurality of regions of memory at a second granularity. For example, memory accesses may be tracked at a first granularity of 4 MB regions and tracked at a second granularity of 4 KB regions. At block 430, processing logic may modify one or more counters associated with memory accesses to the plurality of regions of memory at the first granularity. For example, one or more counters may be updated to indicate a region has been accessed and/or one or more counters may be reset. In some embodiments, counters may be reset when a page table entry associated with a region of memory has been evicted from the page table. In some embodiments, access counters may be stored in an AIT and/or a TLB of a memory device.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each operatively coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, which may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A memory buffer device coupled to a device memory comprising a plurality of regions, wherein the memory buffer device identifies frequently accessed regions of the plurality of regions by counting accesses to the plurality of regions at a first granularity, wherein the frequently accessed regions are associated with counters that satisfy a threshold criterion and are further tracked using a filter at a second granularity, wherein the second granularity is smaller than the first granularity.

2. The memory buffer device of claim 1, wherein accesses to the plurality of regions at the first granularity are tracked for a first duration and accesses to the frequently accessed regions at the second granularity are tracked for a second duration.

3. The memory buffer device of claim 2, wherein the first duration and the second duration are different.

4. The memory buffer device of claim 1, wherein the filter is a at least one of:
a bloom filter; or
a counting bloom filter.

5. The memory buffer device of claim 1, wherein at least a portion of at least one frequently accessed region tracked at the second granularity is cached by the memory buffer device.

6. The memory buffer device of claim 1, wherein counts associated with accesses to the plurality of regions at the first granularity are stored within one or more address translation tables.

7. The memory buffer device of claim 1, wherein counting accesses to the plurality of regions at the first granularity is responsive to a memory request satisfying a counting criterion.

8. The memory buffer device of claim 7, wherein the counting criterion comprises at least one of:
the memory request is for an address within a range of counting addresses;
the memory request is from a first host of a plurality of hosts; or
the memory request is for an address associated with a first virtual machine of a plurality of virtual machines.

9. The memory buffer device of claim 1, wherein the memory buffer device is part of at least one of:
a memory module; or
a compute express link (CXL) module.

10. A memory buffer device coupled to a device memory comprising a plurality of regions, the memory buffer device comprising a first filter and a second filter, wherein the first filter tracks memory accesses to the plurality of regions, and wherein the second filter tracks memory accesses to a subset of the plurality of regions identified as frequently accessed by the first filter.

11. The memory buffer device of claim 10, wherein the first filter tracks memory accesses at a first granularity, and the second filter tracks memory accesses at a second granularity, wherein the first granularity is larger than the second granularity.

12. The memory buffer device of claim 11, further comprising counters associated with memory accesses tracked by the first filter at the first granularity.

13. The memory buffer device of claim 12, wherein the counters are stored within one or more address translation tables.

14. The memory buffer device of claim 10, wherein the first filter is reset at an end of a first duration and the second filter is reset at an end of a second duration, wherein the end of the first duration and the end of the second duration occur at different times.

15. The memory buffer device of claim 10, wherein the second filter is at least one of:
a bloom filter; or
a counting bloom filter.

16. The memory buffer device of claim 10, wherein the first filter tracks memory accesses to the plurality of regions responsive to receiving a memory request for an address associated with a first virtual machine of a plurality of virtual machines.

17. A memory module comprising:
a plurality of memory devices comprising a plurality of regions; and
a memory buffer device coupled to the plurality of memory devices, wherein the memory buffer device comprises:
a first filter and a second filter, wherein the first filter tracks memory access to the plurality of regions, and wherein the second filter tracks memory accesses to a subset of the plurality of regions identified as frequently accessed by the first filter.

18. The memory module of claim 17, wherein the first filter tracks memory accesses at a first granularity, and the second filter tracks memory accesses at a second granularity, wherein the first granularity is larger than the second granularity.

19. The memory module of claim 18, further comprising counters associated with memory accesses tracked by the first filter at the first granularity.

20. The memory module of claim 17, wherein the first filter is reset at an end of a first duration and the second filter is reset at an end of a second duration, wherein the end of the first duration and the end of the second duration occur at different times.
